(19) United States
(12) Patent Application Publication
(10) Pub. No.: US 2023/0399816 A1
(43) Pub. Date: Dec. 14, 2023

(54) METHOD FOR ESTIMATING A PAYLOAD OF A HYDRAULIC MINING SHOVEL

(71) Applicant: Caterpillar Global Mining LLC, Tucson, AZ (US)

(72) Inventors: Sharath CUGATI, Dortmund (DE); Martin KUNIGK, Bochum (DE); Arthur CESARZ, Burscheld (DE)

(73) Assignee: Caterpillar Global Mining LLC, Tucson, AZ (US)

(21) Appl. No.: 18/035,215

(22) PCT Filed: Oct. 19, 2021
(86) PCT No.: PCT/US2021/055496

§ 371 Date: May 3, 2023

(30) Foreign Application Priority Data
Nov. 9, 2020 (GB) 2017656.6

(51) Int. Cl. E02F 9/22; E02F 9/26

(52) U.S. Cl. CPC E02F 9/2221; E02F 9/264

(57) ABSTRACT

The present invention pertains to a method for estimating a payload of a hydraulic mining shovel comprising an attachment having a bucket and at least one hydraulic cylinder. The method comprising the steps of determining a current position of the bucket, measuring a cylinder pressure and an angular attachment acceleration, estimating a dynamic cylinder pressure based on the angular attachment acceleration, calculating an estimated static cylinder pressure and retrieving a payload estimation. The present invention also pertains to a hydraulic mining shovel comprising a system being configured to carry out such method.

### TECHNICAL FIELD

The present invention pertains to a method for estimating a payload of a hydraulic mining shovel comprising an attachment having a bucket and at least one hydraulic cylinder. Some embodiments of the present disclosure relate to a hydraulic mining shovel comprising a system configured to carry out such method.

### TECHNOLOGICAL BACKGROUND

During the operation of hydraulic machine units, in particular during the operation of mining shovels, it is important to be able to retrieve information about the payload mass currently present in the attachment. Knowledge of the payload is needed to improve safety and productivity by reducing incidents of overloading haul trucks. In the mining industry, truck overloading occurs primarily because mining sites receive productivity benefits if truck capacity is maximized. Consequently, loading the maximum possible amount of material into each truck is desired. However, overfilling of haul trucks may damage vehicles and roadways. Furthermore, on public roadways overfilled haul trucks may incur overweight fines. In view thereof, it is a general desire to know the weight of the payload currently present in the bucket of the hydraulic mining shovel. Knowing the payload weight within the bucket allows precise loading of the haul trucks.

Field operation shows that in order to make practical use of a payload estimation, estimating the payload currently in a bucket with an accuracy of about 5% is required. In addition, such a payload estimation further needs to be provided at a point of time while the attachment is moving to allow executing countermeasures in a time-efficient manner and to avoid interruptions during operation.

Current operation assist systems of hydraulic mining shovels readily provide cylinder positions, attachment velocities and acceleration data as well as cylinder pressures for operating the hydraulic mining shovel.

In order to gain knowledge about the payload currently present in the bucket of the hydraulic mining shovel, it is known from the state of the art to perform an online weighing procedure of the bucket or the attachment as a whole during operation and to compare the measured weight against a data set. However, in field operation, hydraulic mining shovels operate at high accelerations, causing substantial dynamic forces acting on the bucket and the attachment and rendering the weight measurements impractical for use as reliable source of payload weight estimation. At the same time, real-time machine simulations had been proven to be too slow due to their computational intensity.

Usually, existing methods for estimating a payload of a hydraulic mining shovel are either too inaccurate or require too much computation power. Hence, there exists a demand for an improved method for estimating a payload of a hydraulic machine unit, allowing a fast and precise payload estimation.

### SUMMARY OF THE INVENTION

Starting from the prior art, it is an objective to provide an improved method for estimating a payload of a hydraulic mining shovel, allowing precise and quick conclusions on the payload weight currently present in the bucket.

This objective is solved by means of a method for estimating a payload of a hydraulic mining shovel with the features of claim 1. Preferred embodiments are set forth in the present specification, the Figures as well as the dependent claims.

Accordingly, a method is provided for estimating a payload of a hydraulic mining shovel comprising an attachment having a bucket and at least one hydraulic cylinder. The method comprises the steps of determining a current position of the bucket, measuring a cylinder pressure and an angular attachment acceleration, estimating a dynamic cylinder pressure based on the angular attachment acceleration, calculating an estimated static cylinder pressure, and retrieving a payload estimation.

The objective is further solved by means of a hydraulic mining shovel comprising a system being configured to carry out the method for estimating a payload with the features of claims 1-14.

### BRIEF DESCRIPTION OF THE DRAWINGS

The present disclosure will be more readily appreciated by reference to the following detailed description when being considered in connection with the accompanying drawings in which:

FIG. 1 schematically shows a perspective view of a hydraulic mining shovel suitable for being used with a method for estimating a payload of the hydraulic mining shovel;

FIG. 2 shows a flow diagram schematically illustrating a method for estimating a payload according to one embodiment;

FIG. 3 shows a flow diagram schematically illustrating a method for estimating a payload according to a further development;

FIG. 4 illustrates geometrical and force-related dependencies of a cylinder in an attachment of a hydraulic mining shovel of the backhoe-type;

FIG. 5 illustrates static forces acting on the cylinder in an attachment of a hydraulic mining shovel of the backhoe-type;

FIG. 6 illustrates dynamic forces acting on the cylinder in an attachment of a hydraulic mining shovel of the backhoe-type;

FIG. 7 illustrates geometrical and force-related dependencies of a cylinder in an attachment of a hydraulic mining shovel of the face-shovel-type;

FIG. 8 illustrates static forces acting on the cylinder in an attachment of a hydraulic mining shovel of the face-shovel-type;

FIG. 9 illustrates dynamic forces acting on the cylinder in an attachment of a hydraulic mining shovel of the face-shovel-type;

FIG. 10 shows a flow diagram of an algorithm for a coordinate transformation;

FIG. 11 shows a flow diagram of an algorithm of a payload calculation algorithm; and

FIG. 12 shows a schematic overview of various components of a payload algorithm.

### DETAILED DESCRIPTION OF PREFERRED EMBODIMENTS

In the following, the invention will be explained in more detail with reference to the accompanying Figures. In the Figures, like elements are denoted by identical reference numerals and repeated description thereof may be omitted in order to avoid redundancies.

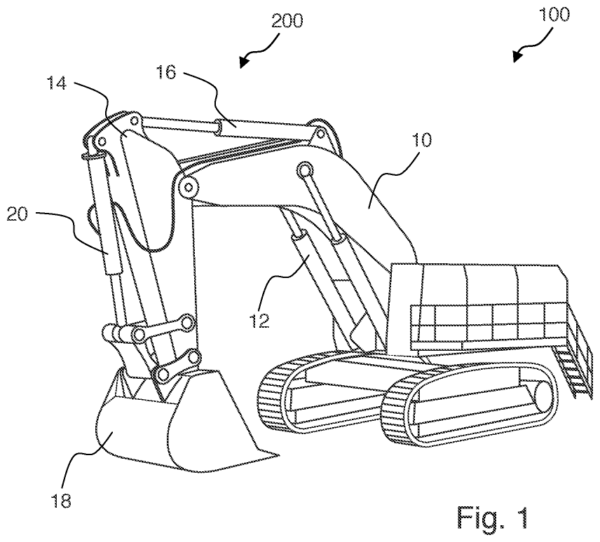

FIG. 1 schematically shows a perspective view of a hydraulic mining shovel 100. Specifically, the hydraulic mining shovel 100 may be used for excavation work in the field of mining, in particular dirt excavation, but is not limited to this application.

The hydraulic mining shovel 100 illustrated in FIG. 1 is a hydraulic mining shovel 100 of the backhoe-type and comprises an attachment 200. On its proximal end, the attachment 200 is rotatably mounted to a chassis of the hydraulic mining shovel 100 via a pin (not shown). The attachment 200 is configured to carry and move a payload at its proximal end. Thereto, the attachment 200 comprises a boom 10 with a boom cylinder 12, a stick 14 with a stick cylinder 16 and a bucket 18 with a bucket cylinder 20.

The boom 10 is rotatably mounted to the chassis of the hydraulic machine 100 and can be articulated via its boom cylinder 12. The stick 14 as well as the stick cylinder 16 each are rotatably mounted to the boom 10 such that the stick 14 may be articulated on the boom 10 via the stick cylinder 16. Likewise, the bucket 18 as well as the bucket cylinder 20 each are rotatably mounted to the stick 14 such that the bucket 18 may be articulated on the stick 14 via the bucket cylinder 20. According to the embodiment shown in FIG. 1, the hydraulic mining shovel 100 is of the backhoe-type. The cylinders 12, 16, 20 are arranged on the attachment 200 in such a way, that forces between the attachment 200 and the cylinders are translated directly. Further, the cylinders 12, 16, 20 are double-acting cylinders. For carrying out the method according to the present disclosure, the minimum hardware components of the attachment 200 are a bucket 18 and one hydraulic cylinder 12. Vice versa, the hydraulic mining shovel 100 is not limited to a maximum number of cylinders 12, 16, 20 and/or linkage members for being used in the method according to the present disclosure.

During operation of the hydraulic mining shovel 100, a digging cycle may be conducted using the attachment 200, comprising the steps of digging into the dirt, loading dirt into the bucket, lifting and moving the bucket to another position and releasing the dirt from the bucket. In the context of the present disclosure, the term payload of the hydraulic mining shovel 100 refers to content loaded into the bucket 18 by mass.

Not shown in FIG. 1 are sensors for acceleration, velocity and angle of each of the boom 10 and the boom cylinder 12, the stick 14 and the stick cylinder 16, the bucket 18 and the bucket cylinder 20 as well pressure sensors for each of the cylinders 12, 16 and 20. Cylinder pressures correspond to the force generated by the cylinders which either work against the forces due to gravity and also to accelerate the attachment 200 to complete a digging cycle. Position, pressures and accelerations of the attachment 200 are measured and provided by the hydraulic mining shovel 100 for further processing by internal operation software of the hydraulic mining shovel 100.

The payload of the hydraulic mining shovel 100 may be received in the bucket 18. During a digging cycle, there exists a need to estimate the payload in the bucket 18 with an accuracy of about 5%. In addition, it is needed to estimate the payload also in a condition in which the attachment 200 is currently moving. As will be shown below, the method for estimating a payload of the hydraulic mining shovel 100 according to the present disclosure may be conducted only on the basis of position, pressure and acceleration information of the attachment.

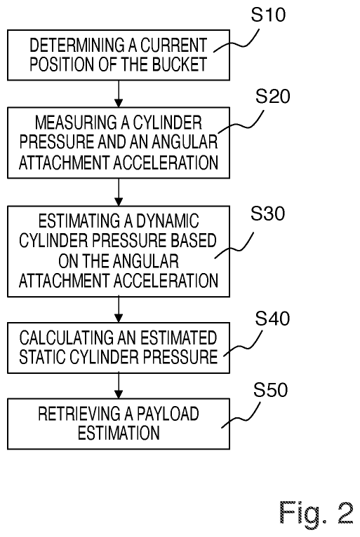

FIG. 2 shows a flow diagram schematically illustrating a method for estimating a payload of a hydraulic mining shovel 100 according to one embodiment. To this end, the method comprises the steps of determining S10 a current position of the bucket 18, measuring S20 a cylinder pressure and an angular attachment acceleration, estimating S30 a dynamic cylinder pressure based on the angular attachment acceleration, calculating S40 and estimated static cylinder pressure and retrieving S50 a payload estimation. The steps S10-S50 may be conducted sequentially.

The step of determining S10 a current position of the bucket 18 may comprise retrieving an attachment angle and/or a cylinder displacement. By retrieving an attachment angle and/or a cylinder displacement, it is possible to identify a definite position of the bucket 18. Said position may be an X-axis and a Y-axis coordinate of the bucket 18 or an information which may be transformed to such coordinates. To this end, the step of determining S10 a current position of the bucket 18 may comprise a step of converting S11 attachment angle into a 2D coordinate representing a tooth position of the bucket 18.

One or more cylinders used in the hydraulic mining shovel 100 may be double-acting cylinders. In this case, the step of measuring S20 a cylinder pressure and an angular attachment acceleration may comprise measuring, in the cylinder 12, a head end pressure and a rod end pressure and subtracting the rod end pressure times an area ratio of the cylinder 12 from the head end pressure. The area ratio of the cylinder 12 may be a cylinder rod end area divided by a cylinder head end area. Thereby, a net cylinder pressure may be calculated.

Estimating a dynamic cylinder pressure based on the angular attachment acceleration may be conducted by utilizing kinematic or dynamic models of the hydraulic mining shovel 100 or the attachment 200. More specifically, the step of estimating S30 a dynamic cylinder pressure based on the angular attachment acceleration may comprise retrieving the dynamic cylinder pressure from a dynamic correlation comprising dynamic cylinder pressures and corresponding angular attachment accelerations for the determined position of the bucket 18. To this end, the dynamic correlation may comprise a lookup table, wherein the dynamic correlation may comprise a simulation algorithm, preferably wherein the simulation algorithm is calculated on the basis of an empty bucket 18 at various attachment accelerations. Alternatively or additionally, the dynamic correlation may also comprise a calibration factor. In other words, the dynamic pressure may be estimated by a lookup table based on angular acceleration. As an example, such a lookup table may have as an input angular acceleration and for an output a pressure value corresponding to the dynamic pressure component.

The step of calculating S40 an estimated static cylinder pressure may comprise calculating the estimated static cylinder pressure by subtracting the dynamic cylinder pressure from the measured cylinder pressure. In other words, the measured cylinder pressure would be reduced by the estimated dynamic component pressure value, originating from the step S30, estimating a dynamic cylinder pressure based on the angular attachment acceleration. Hence, knowing the measured cylinder pressure and the dynamic cylinder pressure component, the static cylinder pressure may be calculated.

The step of retrieving S50 a payload estimation may comprise comparing the estimated static cylinder pressure against a correlation comprising static cylinder pressures and corresponding payloads for the determined position of the bucket 18. Thereto, the step of retrieving S50 may comprise retrieving static cylinder pressures corresponding to various payloads for a given position as X-axis values, retrieving the corresponding payloads as Y axis values, retrieving the estimated static cylinder pressure for the given position as X-axis value and extrapolating the retrieved X-axis value from the X, Y map.

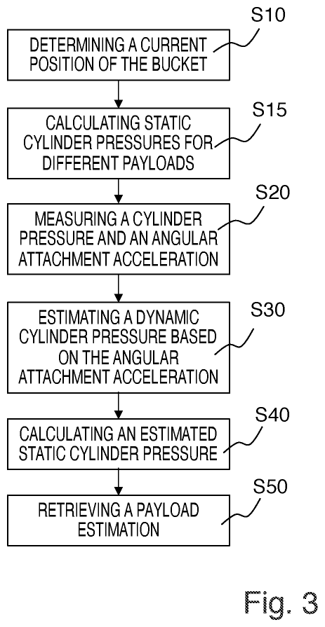

FIG. 3 shows a flow diagram schematically illustrating a method for estimating a payload according to another embodiment. The embodiment shown in FIG. 3 differs from the embodiment of FIG. 2 in so far, as the method disclosed in FIG. 3 further comprises a step of calculating S15, for the determine bucket position, static cylinder pressures for different payloads in order to generate a correlation, preferably wherein the correlation comprises a static pressure versus payload lookup table. The step of calculating, S15, static cylinder pressures for different payloads may be conducted in the disclosed sequential order. However, the step of calculating, S15, static cylinder pressures for different payloads may also be conducted at any time prior to the step of retrieving, S50, a payload estimation by comparing the estimated static cylinder pressure against the correlation.

The step of calculating S15 for determined bucket position static cylinder pressures for different payloads may comprise static cylinder pressures for payloads of 0 tons, 10 tons, 20 tons, 30 tons, 40 tons, 50 tons, 60 tons and/or tons. The latter may be referred to as a payload list.

In general, such a payload list may be based on machine capacity. Instead of utilizing payloads directly, other expressions of the payloads provided in the payload list may be utilized, in particular, dimensionless expressions of the payloads. As an example, the payloads may be expressed dimensionless by dividing the payloads by the maximum payload. To this end, the static cylinder pressures may also be comprised for payloads provided or expressed in the form of percentages such as 0, 20% 40% . . . 100% and 120% of a given maximum payload. Likewise, the static cylinder pressures may be comprised for payloads provided or expressed in the form of 0, 0.2, 0.4 . . . 1 and 1.2-multipliers, being normalized by the maximum payload respectively. Further, any other subdivision, nondimensionalization and/or expression of the payloads may be utilized.

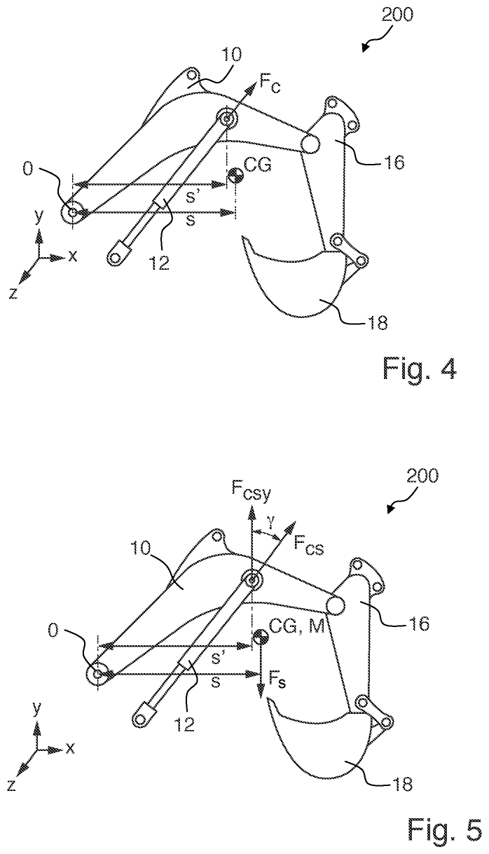

In order to calculate static cylinder pressures for different payloads at a given position of the bucket 18, equations covering static forces needs to be provided in a static pressure model. Likewise, in order to calculate the dynamic cylinder pressure based on the angular attachment acceleration during the estimation step S30, equations covering dynamic forces needs to be provided in a dynamic pressure model. Equations for static and dynamic force calculations will be explained in FIGS. 4-9 as follows.

FIG. 4 illustrates geometrical and force-related dependencies of the cylinder and an attachment 200 of a hydraulic mining shovel 100 of the backhoe type. According to this illustration, the attachment 200 comprises a boom 10 with a boom cylinder 12, a stick 14 and a bucket 18. For the sake of clarity, further cylinders and components, which would be required for operating the attachment 200, are not shown in FIG. 4.

The boom 10 of the attachment 200 is rotatably mounted at a rotation point O. As can be taken from the illustrated Cartesian coordinate system in FIG. 4, the boom 10 may be rotated in the x-y-plane about the rotation point O. Also shown in FIG. 4 is the center of gravity CG of the attachment 200. The cylinder pressures correspond to the force generated by the cylinder 12 to either work against the forces due to gravity G and also to accelerate the attachment 200 to complete a truck loading cycle. The force generated by the boom cylinder 12 is indicated as force F_{c}. The horizontal distance of the center of gravity CG from the rotation point O is indicated by the distance s. The horizontal distance of the cylinder contact point on the boom 10 from the rotation point O is indicated by the distance s′.

In in the embodiment shown in FIG. 4, the boom cylinder 12 is a double acting cylinder. Therefore, the boom cylinder 12 comprises two separate pressure chambers, namely a head end pressure chamber and a rod end pressure chamber. In order to calculate the force F_{c} generated by the boom cylinder 12 based on the pressure of the boom cylinder 12, a resolved pressure μ_{Bm} in the boom cylinder 12 needs to be calculated, considering both the head end pressure and the rod end pressure. Thereto, an area ratio ar of the boom cylinder 12 may be defined as follows:

$$ar = \frac{{A}_{BmRE}}{{A}_{BmHE}} \qquad 1 )$$

wherein A_{BmRE} is the boom cylinder rod end area and A_{BmHE} is the boom cylinder head end area. The resolved pressure P_{Bm} in the boom cylinder 12 may be calculated as follows:

P_{Bm}=P_{BmHE}−(ar·P_{BmRE}) 2)

wherein P_{BmHE} is the head end pressure in the boom cylinder 12 and P_{BmRE} is the rod end pressure in the boom cylinder 12. The force F_{c} generated by the boom cylinder may be calculated as follows:

F_{c}=A_{BmHE}*P_{Bm} 3)

The measured boom pressure P_{Bm} includes both static and dynamic pressure components. However, in order to conduct the method of estimating a payload of a hydraulic mining shovel 100 according the present disclosure, it is required to identify/estimate the dynamic pressure component of a measured boom pressure P_{Bm}.

The boom cylinder 12 force F_{c} at any instance is a sum of the static force F_{cs} to hold the attachment 200 against gravity in that position and a dynamic force F_{ds}, needed to accelerate the attachment 200:

F_{c}=F_{cs}+F_{ds} 4)

In other words, F_{cc} is the static component of the cylinder force F_{c} to balance the gravitational force, and F_{ds} is the dynamic component of the cylinder force F_{c} that accelerates the attachment 200.

FIG. 5 illustrates the static forces acting on the boom cylinder 12 and an attachment 200 of the hydraulic mining shovel 100 of the backhoe type. Therein, the static force Fₛ may be calculated as follows:

Fₛ=M*9.81 5)

The static cylinder force F_{cs} has a y-component F_{csy} which is acting parallel and opposite to the static force F_{z}. The mass of the complete attachment with or without payload at any instance is referenced by M.

To this end, the force balance equations for calculating the static component of a cylinder pressure of may be expressed as follows:

$${F}_{s} * s = {F}_{csy} * {s}^{′} \qquad 6 )$$

$${F}_{csy} = \frac{{F}_{s} * s}{{s}^{′}} \qquad 7 )$$

$${F}_{cs} = \frac{{F}_{csy}}{cos γ} \qquad 8 )$$

$${P}_{Bms} = \frac{{F}_{cs}}{{A}_{BmHE}} \qquad 9 )$$

Again, in summary, is the pressure in the boom cylinder 10 due to the static force.

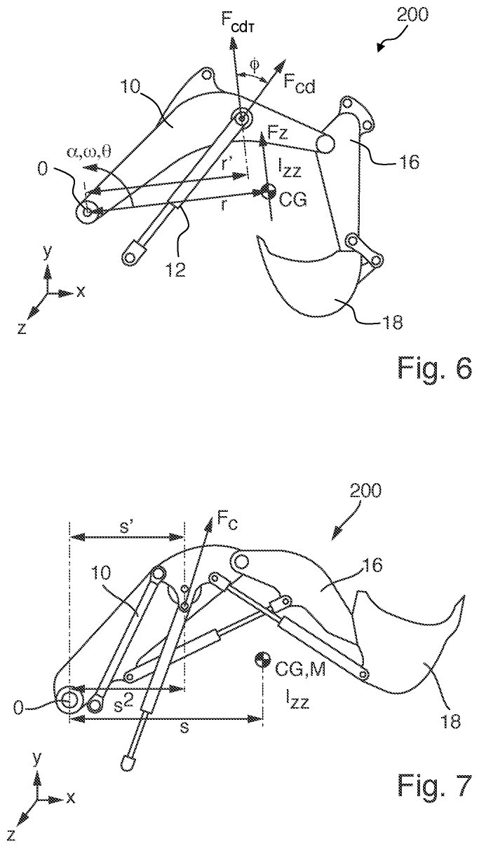

FIG. 6 illustrates the dynamic forces acting on the boom cylinder 10 in an attachment 200 of a hydraulic mining shovel 100 of the backhoe-type. Therein, the torque/momentum τ around point O is defined as follows:

τ=I_{zz}*a 10)

Wherein I_{zz} is the inertia of the complete attachment 200 at the center of gravity CG with or without payload at any instance. The angular acceleration of the boom 10 around point O is defined as x. Further, the torque τ may be calculated as follows:

τ=F_{τ}*r 11)
wherein F_{τ} is the force normal for the radius r generates a momentum τ
around point v. The radial distance of CG from the rotation point O is defined as r. The force balance equation may then be written as:

F_{τ}*r=F_{cdτ}*r′ 12)

wherein r′ is the projected distance of a contact point of the boom cylinder 10 and the rotation point O on the radius r. The force perpendicular to r′ that generates momentum r around point O is defined as and F_{cdr}, F_{τ} and F_{cdτ} are parallel to each other. More precisely, F_{cdτ} is the transformation of F_{τ}. Based on measuring angle acceleration α, F_{cdτ} may be calculated as follows:

$${F}_{cd τ} = \text{?} \qquad 13 )$$

$$\text{?} = \frac{{F}_{cd τ}}{cos ∅} \qquad 14 )$$

$${P}_{Bmd} = \frac{{F}_{cd}}{{A}_{BmHE}} \qquad 15 )$$

$$\text{?} \qquad 16 )$$

$$\text{?} \text{indicates text missing or illegible when filed}$$

FIG. 7 illustrates the geometrical and force related dependencies of a boom cylinder 10 in attachment 200 of a hydraulic mining shovel 100 of the face-shovel type. In principle, the same equations apply as set forth above for the embodiment of a hydraulic mining shovel 100 of the backhoe type. However, in the case of the face-shovel type hydraulic mining shovel 100, the boom cylinder 12 is arranged in the attachment 200 via a tri-power linkage 22. As a consequence, forces between the attachment 200 and the boom cylinder 12 are calculated as indirectly translated forces as it will be shown below.

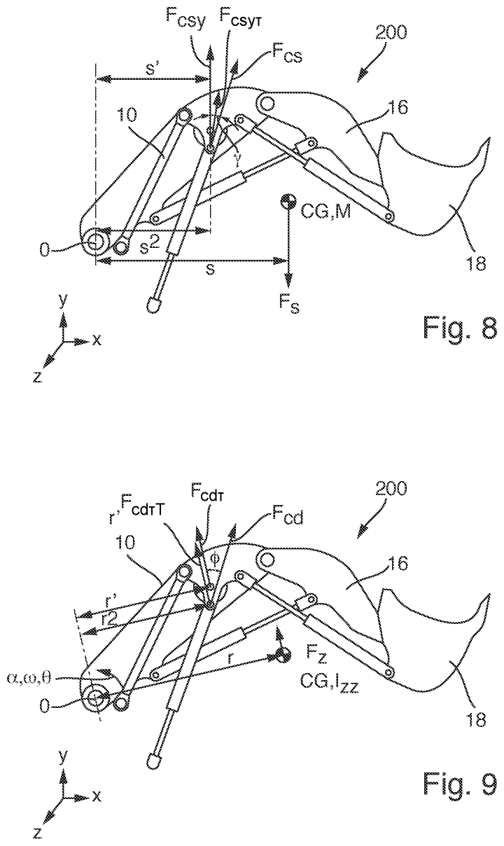

FIG. 8 illustrates the static forces acting on the boom cylinder 10 in attachment 200 of the hydraulic mining shovel 100 of the face shovel type. The same equations apply as set forth above for the embodiment of a hydraulic mining shovel 100 of the backhoe type, except for the force F_{csy}, which is transformed to F_{cxyτ} according to its contact point between the boom cylinder 12 and the tri-power linkage 22. Hence equation (8) is modified as follows:

$${F}_{cs} = \frac{{F}_{csyT}}{cos γ} \qquad 17 )$$

FIG. 9 illustrates dynamic forces acting on the boom cylinder 10 in attachment 200 of the hydraulic mining shovel 100 of the face shovel type. Also here, in principle the same equations apply as set forth above for the embodiment of a hydraulic mining shovel 100 of the backhoe type with the following exceptions. The distance r′ is the projected distance of the contact point on the boom cylinder 10 and the tri-power linkage 22 on the radius r.

Measuring the angular acceleration α, it is possible to calculate F_{cdτ} as follows:

$${F}_{τ} * r = {F}_{cd τ} * {r}^{′} \qquad 18 )$$

$${F}_{cd} = \frac{\text{?}}{cos ∅} \qquad 19 )$$

$${P}_{Bmd} = \frac{{F}_{cd}}{{A}_{BmHE}} \qquad 20 )$$

$${P}_{Bm} = \text{?} + {P}_{Bmd} \qquad 21 )$$

$$\text{?} \text{indicates text missing or illegible when filed}$$

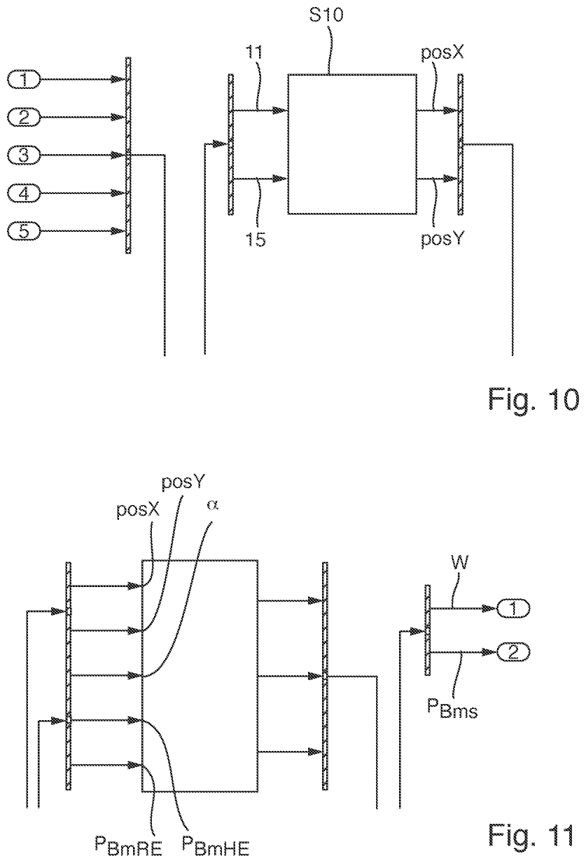

FIG. 10 shows a flow diagram of an algorithm for a coordinate transformation. In step S10, a current position of the bucket 18 is determined. In the context of the present disclosure, the term position refers to any information suitable to allow a conclusion about the bucket in a 1D, 2D or 3D dimension. In this step, a current position of the bucket 18 may comprise retrieving attachment angles 11; 15 and/or a cylinder displacement. Attachment angles 11; 15 may for example be retrieved using an inclination sensor or an accelerometer. As set forth in the flow diagram of FIG. 10, the attachment angles 11; 15 may be converted into a two-dimensional coordinate representing a tooth position of the bucket 18. More precisely, a coordinate transformation may comprise retrieving a boom angle 11 and a stick angle 15 as an input and may provide, as an output, an x-position posX as well as a y-position posY of a bucket tooth in the form of a coordinate, representing the current position of a bucket tooth in the x-y plane.

FIG. 11 shows a flow diagram of an algorithm of a payload W calculation. The depicted representation of the algorithm is simplified to such an extent that only the input and output parameters are shown. In general, the algorithm tries to predict, dynamically, the payload of the hydraulic mining shovel 100. To this end, the x-position posX and the y-position posY of a bucket tooth is received as an input, originating from the output of the determination step S10. Further, the measured cylinder pressure P_{Bm} is received in the shape of the cylinder head end pressure P_{BmHE} as well as the cylinder rod end pressure P_{BmRE}. In addition, the angular attachment acceleration α is retrieved. Cylinder pressures and the angular attachment acceleration α originate from the measuring step S20.

The payload calculation algorithm estimates a dynamic cylinder pressure P_{Bmα} based on the angular attachment acceleration α and an estimation step S30. Further, the payload calculation algorithm calculates in a calculation step S40 an estimated static cylinder pressure P_{Bms} by subtracting the dynamic cylinder pressure P_{Bmd} from the measured cylinder pressure P_{Bm}. The output of the payload calculation algorithm is the static cylinder pressure P_{Bmo} and the corresponding payload W.

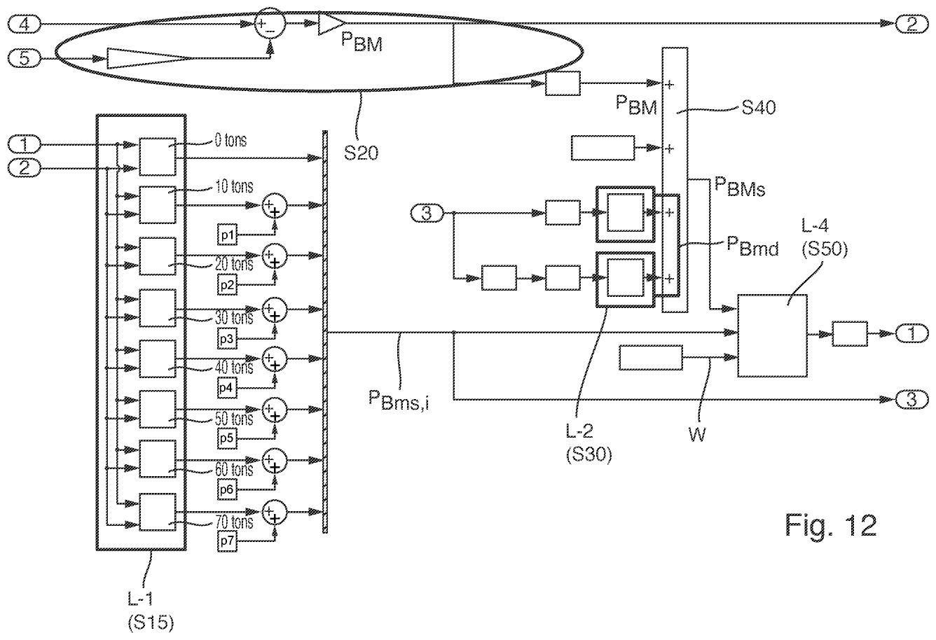

The functionality of the payload algorithm is depicted in FIG. 12, showing a schematical overview of various components of the payload algorithm.

Once the current position of the bucket 18 had been determined in a determination step S10, static cylinder pressures P_{Bmz} may be calculated for the determined bucket position. More precisely, in a calculation step S15, static cylinder pressures P_{Bms} for different payloads may be calculated, in order to generate a correlation L-1, which may have the form of a lookup table L-1, comprising various static pressures P_{Bms,i} for different payloads. As shown on the left lower side of FIG. 12, the static pressure look up table of L-1 comprises static cylinder pressures for payloads 0 tons, 10 tons, 20 tons, 30 tons, 40 tons, 50 tons, 60 tons, and 70 tons.

Instead of utilizing payloads directly, other expressions of the payloads provided in the payload list may be utilized, in particular, dimensionless expressions of the payloads. As an example, the payloads may be expressed dimensionless by dividing the payloads by the maximum payload. To this end, the static cylinder pressures may also be comprised for payloads provided or expressed in the form of percentages such as 0, 20% 40% . . . 100% and 120% of a given maximum payload. Likewise, the static cylinder pressures may be comprised for payloads provided or expressed in the form of 0, 0.2, 0.4 . . . 1 and 1.2-multipliers, being normalized by the maximum payload respectively. Further, any other subdivision, nondimensionalization and/or expression of the payloads may be utilized.

Additionally, or alternatively, the lookup table L-1 may comprise data covering positions and static cylinder pressures P_{Bms} for a constant payload.

Generating the lookup table L-1 for the static cylinder pressures P_{Bms} is conducted during the calculation step S15. Preferably, if the calculation step S15 is repeated for different positions, a 3D map may be generated, covering bucket position, payloads W and static pressures P_{Bms}. Within the lookup table L-1, the bucket position may be represented as attachment angle or as x, y-coordinate of the bucket tooth after the coordinate transformation. Alternatively, the bucket position may be stored as boom cylinder displacement or any other parameter useful to determine the bucket position.

As depicted in the top of FIG. 12, measuring the cylinder pressure in the measuring step S20, comprises measuring, the cylinder head end pressure and a rod end pressure and subtracting the rod end pressure times in area ratio ar of the cylinder 12 to the head end pressure. As set forth above in equation (1), the area ratio ar of the cylinder 12 is a cylinder rod end area divided by a cylinder head end area. This way, a net pressure of the boom cylinder 10 may be retrieved.

In the middle right section of FIG. 12, the step of estimating S30 of a dynamic cylinder pressure based on the angle attachment acceleration (and/or also jerk) is depicted. Thereto, a dynamic cylinder pressure P_{Bmi} is retrieved from a dynamic correlation L-2 in the shape of a dynamic lookup table comprising dynamic cylinder pressures and corresponding angle attachment accelerations (and/or jerk) for the determined position of the bucket. The dynamic correlation L-2 in the shape of a dynamic look up table may be established by utilizing a simulation algorithm. The simulation algorithm may be calculated on the basis of an empty bucket 18 at various attachment accelerations α.

In this dynamic simulation algorithm, the entire hydraulic mining shovel 100 may be modeled. By means of suitable equations, it is possible to simulate the dynamic cylinder pressure F_{Bmd} for a given acceleration. More precisely, it is possible to quantify the dynamic component of a cylinder pressure. This dynamic component represents the pressure that is actually needed to accelerate of the boom 10. In addition thereto, a calibration factor may be provided in order to compensate offsets or peaks originating from the simulation. Estimating the dynamic cylinder pressure based on the angular attachment acceleration α is conducted in the estimation step S30. The estimation step outputs the dynamic pressure P_{Bmd}.

The calculation step S40 for calculating an estimated static cylinder pressure is shown in the upper right part of FIG. 12. Calculating the estimated static cylinder pressure P_{Bma} is achieved by subtracting the dynamic cylinder pressure P_{Bmd} from the measured cylinder pressure P_{Bm}. The calculation step S40 for calculating the estimated static cylinder pressure may comprise considering a pressure offset calibration and/or correction factor. The output of the calculation step S40 is an estimated static cylinder pressure P_{Bms}.

The retrieving step S50 retrieving a payload estimation is shown in the lower right of FIG. 12. Retrieving a payload estimation may be achieved by comparing the estimated static cylinder pressure against a correlation L-1. In this case, the retrieving step S50 is in the shape of a lookup table L-4. The lookup table L-4 retrieves the estimated static cylinder pressure P_{Bms} as an input. Further, the lookup table L-4 retrieves a correlation covering static cylinder pressures P_{Bms} for several payloads W and different positions.

Within the step of retrieving S50 of a payload estimation the payload W is estimated by identifying the received estimated static cylinder pressure P_{Bms} within the correlation L-1 of static cylinder pressures and corresponding payloads. In other words, the data provided by the static pressure look up table L-1 is extrapolated such that it outputs an estimated payload value for the received estimated static cylinder pressure. Hence, the final output of the retrieving step S50 is a payload W value which is based on an extrapolation.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

A method may be provided for estimating a payload of a hydraulic mining shovel comprising an attachment having a bucket and at least one hydraulic cylinder. The method may comprise the steps of determining a current position of the bucket, measuring a cylinder pressure and an angular attachment acceleration, estimating a dynamic cylinder pressure based on the angular attachment acceleration, calculating an estimated static cylinder pressure, and retrieving a payload estimation.

By that, it is possible to isolate a static cylinder pressure of an attachment of a measured total cylinder pressure even in the circumstances where dominant dynamic forces act on the hydraulic cylinder. This isolated dynamic pressure may then be used to identify the payload currently present in the bucket of the hydraulic mining shovel.

Typically, in such a hydraulic mining shovel, the attachment is rotatably connected to the hydraulic mining shovel on its proximal end and comprises a bucket on its distal end. By means of the at least one hydraulic cylinder, the attachment may be altered at least in a two-dimensional range. In addition thereto, hydraulic mining shovels typically comprise components to accelerate the attachment or the hydraulic mining shovel as a whole in at least one dimension of freedom.

Typically, hydraulic mining shovels comprise various sensors and internal processing tools, by means of which cylinder positions, velocity and acceleration data as well as cylinder pressures may be provided. To this end, the angle of each component of the attachment is readily available at any point of time during operation.

At any point of time during operation, a need to estimate the current payload in the bucket with an accuracy of about 5% may arise even while the attachment is moving. In the context of the present disclosure, the term payload refers to payload mass currently present within the bucket. In the proposed method, the estimation of a payload may be achieved on the basis of calculating an estimated static cylinder pressure by subtracting the dynamic cylinder pressure from the measured cylinder pressure. In this way, the proposed method enables linearizing a superposition of static and dynamic pressure components down to an estimated static pressure. In a subsequent step, this estimated static pressure may then serve as a basis for retrieving the payload estimation.

In this way, the readily available cylinder position, velocity and acceleration data as well as cylinder pressures are fully sufficient as an input for the estimation algorithm. Furthermore, the method for estimating the payload of the hydraulic mining shovel may be initiated at any time during operation of the hydraulic mining shovel in particular during a movement of the attachment.

Thus, by calculating an estimated static cylinder pressure by subtracting the dynamic cylinder pressure from the measured cylinder pressure, a robust and fast method may be provided that, in addition, may be cost—effectively implemented.

In a further development, the method may further comprise a step of calculating, for the determined bucket position, static cylinder pressures for different payloads in order to generate the correlation, preferably wherein the correlation comprises a static versus payload lookup table. For example, the payload lookup table may comprise static cylinder pressures for the payloads 0 tons, 10 tons, 20 tons, 30 tons, 40 tons, 50 tons, 60 tons and/or 70 tons. Those values may for example be calculated applying basic static equations on the known geometry of the attachment under consideration of the current determined position of the bucket. Thereby, instant calculation results may be achieved due to low processing power requirements.

Instead of utilizing payloads directly, other expressions of the payloads provided in the payload list may be utilized, in particular, dimensionless expressions of the payloads. As an example, the payloads may be expressed dimensionless by dividing the payloads by the maximum payload. To this end, the static cylinder pressures may also be comprised for payloads provided or expressed in the form of percentages such as 0, 20% 40% . . . 100% and 120% of a given maximum payload. Likewise, the static cylinder pressures may be comprised for payloads provided or expressed in the form of 0, 0.2, 0.4 . . . 1 and 1.2-multipliers, being normalized by the maximum payload respectively. Further, any other subdivision, nondimensionalization and/or expression of the payloads may be utilized.

In a further development, the step of determining a current position of the bucket may comprise retrieving an attachment angle and/or a cylinder displacement. In addition, the retrieved attachment angle may further be converted into a two-dimensional coordinate representing a tooth position of the bucket in a further step. As a result, the current position of the bucket may be provided by means of a simple X-Y position which may then be conveniently provided for further processing within the estimation algorithm.

Furthermore, the step of measuring a cylinder pressure may comprise measuring, in the cylinder, a head end pressure and a rod end pressure and subtracting the rod end pressure times in area ratio of the cylinder from the head end pressure, wherein the area ratio of the cylinder is a cylinder rod end area divided by a cylinder head end area. Thereby, the effective pressure of the cylinder may be determined for double-acting cylinders.

In a further development, the step of estimating a dynamic cylinder pressure may comprise retrieving the dynamic cylinder pressure from a dynamic correlation comprising dynamic cylinder pressures corresponding angular attachment accelerations for the determined position of the bucket. Such a dynamic correlation may for example comprise kinematic models, representing cylinders, valves, pumps and other components and allows to identify the amount of pressure that is actually used to accelerate the attachment. To this end, it is possible to subsequently differentiate between static and dynamic pressure components from a measured pressure value.

For example, the dynamic correlation may comprise a lookup table, or the dynamic correlation comprises a simulation algorithm preferably wherein the simulation algorithm is calculated on the basis of an empty bucket at various attachment accelerations. Additionally or alternatively, the dynamic correlation may comprise a calibration factor. By means of such a calibration factor, the dynamic correlation may be fine-tuned. In particular, in situations of high acceleration values a calibration factor may dampen the result of the dynamic relation based on experimental data.

In a further development, the step of calculating the estimated static cylinder pressure comprises the step of subtracting the dynamic cylinder pressure from the measured cylinder pressure. By that, the measured total cylinder pressure, comprising static and dynamic cylinder pressures, may be represented by an estimated static cylinder pressure only. This way, a low cost and time efficient simplification of the measured cylinder pressure may be achieved.

In a further development, the step of retrieving a payload estimation (S50) comprises comparing the estimated static cylinder pressure against the correlation comprising static cylinder pressures and corresponding payloads for the determined position of the bucket. This way, a low cost and time efficient calculation of the payload currently present within the bucket may be achieved.

Further, the step of retrieving a payload estimation (S50) may comprise retrieving static cylinder pressures corresponding to various payloads for a given position as X-axis values, retrieving the corresponding payloads as Y-axis values, retrieving the estimated static cylinder pressure for the given position as X-axis value, and extrapolating retrieved X-axis value from the X, Y map. In effect, a one-dimensional output may be retrieved on the basis of a multidimensional data space.

In a preferred embodiment, the method may comprise a boom with a boom cylinder, a stick with a stick cylinder in a bucket cylinder for the bucket. In general, all components of the attachment need to be considered in order to allow a precise estimation of a payload of a hydraulic mining shovel. In particular, sufficient data for all the attachment components must be available in order to determine a current position of the bucket.

In a further embodiment, the hydraulic mining shovel may be of the backhoe—type, wherein the forces between the attachment and the cylinder are calculated as directly translated forces. According to an alternative embodiment, the hydraulic mining shovel may be of the face—shovel type, wherein the cylinder is arranged on the attachment via a tri-power linkage, wherein the forces between the attachment and the cylinder are calculated as indirectly translated forces. Either way, the payload estimation algorithm operates equally for backhoe type and face shovel type hydraulic mining shovels. However, in the case of a face-shovel type hydraulic mining shovel, the indirectly translated forces by the tri-power need to be considered in the calculation of forces and measurements of pressures. Likewise, the backhoe method of calculation is also applicable for other face shovel models without tri-power linkage configuration as well.

In a further embodiment, the method may further comprise conducting a digging cycle using the attachment comprising the steps of digging into dirt, lifting and moving the bucket to another position, and releasing the dirt from the bucket, wherein the steps for estimating the payload are conducted during any point of time of the digging cycle. For example, the steps for estimating the payload may be conducted after completing the step of loading the dirt into the bucket. After completing the step of loading the dirt into the bucket, the payload within the bucket remains roughly the same in most cases. At this time, is the earliest convenience to estimates the payload of the hydraulic mining shovel, which allows a time efficient decision whether to accept or to change the payload of the hydraulic mining shovel.

The proposed method for estimating a payload of a hydraulic mining shovel may be employed in a hydraulic mining shovel comprising a system for carrying out said method. Specifically, the system of the hydraulic mining shovel may be configured to carry out the method according to the disclosure provided above. According to the present disclosure, the system may comprise hardware and/or software components as disclosed above. Technical features which are described in connection with the above method for estimating a payload of a hydraulic mining shovel may also related and be applied to the proposed hydraulic mining shovel, and vice versa.

### INDUSTRIAL APPLICABILITY

With reference to the Figures, a method for estimating a payload of a hydraulic mining shovel and a hydraulic mining shovel comprising a system being configured for carrying out said method are proposed. The method as mentioned above is applicable in hydraulic mining shovels but also in any work tool comprising a hydraulically operated attachment suitable for carrying a payload.

According to a general aspect of the disclosure, it is possible to isolate a static cylinder pressure of an attachment of a measured total cylinder pressure even in the circumstances where dominant dynamic forces act on the hydraulic cylinder. This isolated dynamic pressure may then be used to identify the payload currently present in the bucket of the hydraulic mining shovel. Thus, by calculating an estimated static cylinder pressure by subtracting the dynamic cylinder pressure from the measured cylinder pressure, a robust and fast method may be provided that, in addition, may be cost—effectively implemented.

According to a further development of the disclosure, instant calculation results may be achieved due to low processing power requirements.

According to a further development of the disclosure, the current position of the bucket may be provided by means of a simple X-Y position which may then be conveniently provided for further processing within the estimation algorithm.

According to a further development of the disclosure, it is possible to subsequently differentiate between static and dynamic pressure components from a measured pressure value.

According to a further development of the disclosure, a low cost and time efficient simplification of the measured cylinder pressure may be achieved.

According to a further development of the disclosure, a low cost and time efficient calculation of the payload currently present within the bucket may be achieved.

A further development of the disclosure allows a time efficient decision whether to accept or to change the payload of the hydraulic mining shovel.

It will be apparent to those skilled in the art that various modifications and variations can be made to the disclosed method and hydraulic mining shovel. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

1. A method for estimating a payload of a hydraulic mining shovel comprising an attachment having a bucket and at least one hydraulic cylinder, the method comprising the steps of
determining a current position of the bucket;
measuring a cylinder pressure and an angular attachment acceleration;
estimating a dynamic cylinder pressure based on the angular attachment acceleration,
calculating an estimated static cylinder pressure; and
retrieving a payload estimation.

2. The method according to claim 1, further comprising a step of calculating, for the determined bucket position, static cylinder pressures for different payloads in order to generate a correlation, preferably wherein the correlation comprises a static pressure lookup table.

3. The method according to claim 1, wherein the step of determining a current position of the bucket comprises retrieving an attachment angle and/or a cylinder displacement.

4. The method according to claim 3, further comprising a step of converting the attachment angle into a 2D coordinate representing a tooth position of the bucket.

5. The method according to claim 1, wherein the step of measuring a cylinder pressure comprises
measuring, in the cylinder, a head end pressure and a rod end pressure and
subtracting the rod end pressure times an area ratio of the cylinder from the head end pressure, wherein the area ratio of the cylinder is a cylinder rod end area divided by cylinder head end area.

6. The method according to claim 1, wherein the step of estimating a dynamic cylinder pressure comprises retrieving the dynamic cylinder pressure from a dynamic correlation comprising dynamic cylinder pressures and corresponding angular attachment accelerations for the determined position of the bucket.

7. The method according to claim 6, wherein the dynamic correlation comprises a lookup table, wherein the dynamic correlation comprises a simulation algorithm, preferably wherein the simulation algorithm is calculated on the basis of an empty bucket at various attachment accelerations.

8. The method according to claim 6, wherein the dynamic correlation comprises a calibration factor.

9. The method according to claim 1, wherein the step of calculating the estimated static cylinder pressure comprises the step of subtracting the dynamic cylinder pressure from the measured cylinder pressure.

10. The method according to claim 1, wherein the step of retrieving a payload estimation comprises comparing the estimated static cylinder pressure against a correlation comprising static cylinder pressures and corresponding payloads for the determined position of the bucket.

11. The method according to claim 10, further comprising
retrieving static cylinder pressures corresponding to various payloads for a given position as x-Axis values;
retrieving the corresponding payloads as y-Axis values;
retrieving the estimated static cylinder pressure for the given position as an x-Axis value; and
extrapolating the retrieved x-Axis value from a map comprising the x- and y-Axis values.

12. The method according to claim 1, wherein the hydraulic mining shovel is of the backhoe-type, wherein the cylinder is arranged on the attachment in such a way that forces between the attachment and the cylinder are translated directly.

13. The method according to claim 1, wherein the hydraulic mining shovel is of the face-shovel type, wherein the cylinder is arranged on the attachment via a tri-power linkage, wherein the forces between the attachment and the cylinder are calculated as indirectly translated forces.

14. The method according to claim 1, further comprising conducting a digging cycle using the attachment comprising the steps of
digging into dirt;
loading the dirt into the bucket;
lifting and moving the bucket to another position; and
releasing the dirt from the bucket s wherein the steps for estimating the payload are conducted during any point of time of the digging cycle, preferably after completing the step of loading the dirt into the bucket.

15. A hydraulic mining shovel comprising a system being configured to carry out the method for estimating a payload according to claim 1.
